(19) United States
(12) Patent Application Publication
(10) Pub. No.: US 2012/0154922 A1
(43) Pub. Date: Jun. 21, 2012

(54) LASER-FOCUSING HEAD WITH ZnS LENSES HAVING A PERIPHERAL THICKNESS OF AT LEAST 5 MM AND LASER CUTTING UNIT AND METHOD USING ONE SUCH FOCUSING HEAD

(75) Inventors: Francis Briand, Paris (FR); Gaia Ballerini, Paris (FR); Isabelle Debecker, Paris (FR); Thomas Jouanneau, Paris (FR); Hakim Maazaoui, Pierrelaye (FR); Eric Verna, Boissy L'Aillerie (FR)

(73) Assignee: L'Air Liquide Societe Anonyme Pour L'Etude Et L'Exploitation Des Procedes Georges Claude, Paris (FR)

(21) Appl. No.: 13/393,280

(22) PCT Filed: Aug. 17, 2010
(86) PCT No.: PCT/FR2010/051723

§ 371 Date: Feb. 29, 2012

(30) Foreign Application Priority Data
Sep. 1, 2009 (FR) 0955949

(51) Int. Cl. G02B 27/30; B23K 26/38

(52) U.S. Cl. 359/641; 219/121.67; 219/121.72

(57) ABSTRACT

The invention relates to a particular optical configuration employed in a solid-state laser, in particular a fiber laser, cutting head for controlling the problems of focal drift and laser damage of the optics of the focusing head and to a laser unit equipped with such a focusing head, in particular an ytterbium-doped fiber laser unit.

The invention relates to a particular optical configuration employed in a solid-state laser, in particular a fiber laser, cutting head for controlling the problems of focal drift and laser damage of the optics of the focusing head and to a laser unit equipped with such a focusing head, in particular an ytterbium-doped fiber laser unit.

The latest generation of solid-state lasers, such as fiber or disk lasers, has benefitted from major advances and combines power levels of several kW with excellent quality factor or BPP (Beam Product Parameter), unlike solid-state lasers such as Nd:YAG lasers.

In addition to the characteristics whereby these lasers are suitable sources for cutting metallic materials, in this case a shorter wavelength (1.07 μm) than that of CO₂ lasers (10.6 μm), which is better absorbed by the metal and transportable by an optical fiber, a smaller overall size and greater reliability, the high brilliance thereof significantly improves the cutting performance on metallic or nonmetallic materials.

Typically, a fiber laser cutting unit comprises a laser source and optical devices for transporting the laser beam right to a cutting head, also called a focusing head, which focuses the beam into the thickness of a part to be cut.

The laser source is an ytterbium (Yb)-doped fiber laser, equipped with at least one beam-conveying optical fiber, and the cutting head comprises optical collimating, redirecting and focusing devices for bringing a focused laser beam up to a part to be cut.

The optical devices, such as the focusing lens, of a laser cutting head must withstand high surface power densities, typically between 1 and 10 kW/cm² depending on the characteristics of the laser source and the diameter of the beam on the optics, and do so sustainably while operating in polluted environments that damage them.

In continuous laser emission mode, damage of the optics is generally manifested in the form of progressive degradation in the performance of the optics, initially with no visible damage, which degradation essentially results from thermal phenomena.

Specifically, the residual absorption by the surface coatings and substrates of the optics leads to nonuniform heating of the optical component and to the build-up of thermal stresses, in particular in the case of transmissive components such as lenses. These mechanisms affect the parameters and the quality of the laser beam and may, after a long period of irradiation, cause the optics to deteriorate: appearance of burn marks, coating delamination, etc.

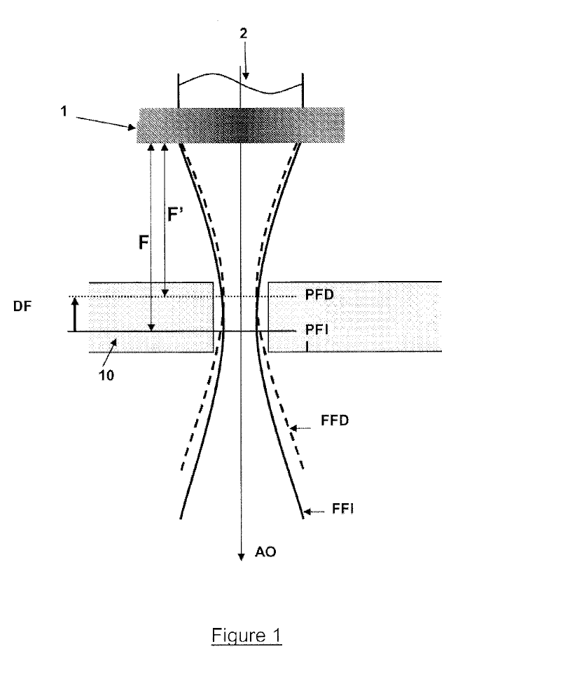

The heating-up of the optics of a cutting head also causes a drift DF in the focal point of the beam, due to the thermal lensing effect, also called focal drift, which is illustrated in FIG. 1. When a lens 1 is being exposed, it is heated at its center by the high-power collimated laser beam 2 delivered along the optical axis (AO), whereas its edges are cooler. A radial thermal gradient is established in the lens 1. The magnitude of this gradient is greater the higher the power density received by the lens 1. This thermal gradient creates a gradient in the refractive index of the material. This phenomenon, combined with the thermal expansion effect of the material of the lens 1, modifies the effective radius of curvature of the lens 1 and modifies the focusing characteristics thereof. The initial focal plane (PFI) of the beam, located at a distance F from the lens, is moved along the propagation direction of the beam, becoming closer to the focusing lens 1, at a distance F′, until it reaches the shifted focal plane (PFD). The initial focused beam (FFI) is then transformed into a shifted focused beam (FFD) having inferior cutting characteristics.

Contamination of the surface of the optics by the environment, i.e. dust, metal spatter or moisture, and the ageing thereof are factors that increase the absorption of the lenses and progressively exacerbate the heat-up, leading to the magnitude of the focal drift increasing over the course of time.

Now, the performance characteristics of an industrial laser cutting process are assessed in terms of cutting speed, cutting quality—namely straight, smooth and burr-free cut faces—and the tolerances on the operating parameters of the process.

A fiber laser cutting process is sensitive to the variations in the position of the focal point of the beam relative to the surface of the part treated, most particularly when very thick plate, namely plate with a thickness of 4 mm and higher, has to be cut. The permitted tolerances on the position of the focal point are typically ±0.5 mm. If the focal position of the laser beam varies beyond the permitted tolerances, it is no longer possible to maintain optimum cutting performance.

One solution is therefore to look for new cutting parameters in order to compensate for the focal drift, or to replace the optics of the focusing head. As a result, the productivity of an automated industrial process is degraded.

A critical problem arises when the position of the focal point varies during the cutting operation as this leads to unequal cutting performance from one part to another, or even from one face to another of the same part.

The phenomena described above show that the durability in the performance of a cutting process is strongly dependent on the resistance of the optical devices for propagating the laser beam. Since the position of the focal position is an important parameter of the fiber laser cutting process, it is essential that the focal position of the beam be as stable as possible and that any drift should remain within the permitted tolerances. The thermal distortions suffered by the optical elements at high power must be minimal in order to prevent them from being damaged. All these requirements must be taken into account when choosing the optics constituting the focusing system of a laser cutting head.

The problem that arises is that there are difficulties in transporting high-brilliance laser beams for cutting applications. The laser power levels available are continuing to increase, but it is the resistance of the optical devices that limits the power levels that can be employed for cutting. This is because high-brilliance beams are characterized by their high power levels combined with excellent quality factors, that is to say low BPP values, for example around 0.33 mm.mrad. This results in very high power densities on the surfaces of the optics of focusing heads and an increase in thermal gradients and distortions. It has also been found that the resistance of the optical materials to laser damage is poorer with high-brilliance lasers than with conventional CO₂ lasers, since the shorter wavelength of the former lasers is more sensitive to defects present in the substrates and in the surface coatings of the optical elements, which may locally cause excessive heat-up.

The problem to be solved is therefore to be able to control the abovementioned difficulties of focal drift and damage of the optics occurring during use of solid-state lasers, in particular when using a fiber laser, especially an ytterbium-doped fiber laser, so as to ensure that the cutting performance lasts, in particular when employing a high-power laser cutting process, that is to say one having a power of at least 1 kW.

The solution of the invention is therefore a laser beam focusing head comprising a collimating lens and a focusing lens, characterized in that the collimating lens and the focusing lens are made of ZnS and have a thickness at the edges of at least 5 mm, and a deflecting mirror operating at an angle of incidence (α) of between 40 and 50° is placed, in the path of the laser beam within said focusing head, between the collimating lens and the focusing lens.

Depending on the case, the focusing head of the invention may have one or more of the following features:
the collimating lens and the focusing lens have a thickness at the edges of between 5 and 10 mm, preferably between 6 and 8 mm;
the collimating lens and the focusing lens have a diameter of between 35 and 55 mm; and
the deflecting mirror is made of silica.
   The invention also relates to a laser cutting unit comprising:
a solid-state laser device emitting a laser beam at a wavelength of between 1.06 and 1.10 μm and a power of between 0.1 and 25 kW,
a focusing head as claimed in one of the preceding claims, and
a conveying fiber connecting the solid-state laser device to the focusing head so as to convey the laser beam emitted by the solid-state laser device to the focusing head.

Depending on the case, the unit of the invention may have one or more of the following features:
the solid-state laser device is of the fiber laser type, preferably an ytterbium-doped fiber laser;
the solid-state laser device emits a laser beam with a power of between 1 and 5 kW in continuous, quasi-continuous or pulsed mode, preferably in continuous mode;
the conveying fiber has a diameter not exceeding 150 μm, preferably a diameter of 50 μm or 100 μm;
the solid-state laser device emits a laser beam having a BPP of between 1.6 and 4 mm.mrad;
the conveying fiber has a diameter of 50 μm and a BPP of between 1.6 and 2.2 mm.mrad, the collimating lens has a focal length of between 70 and 120 mm and the focusing lens has a focal length of between 200 and 450 mm. More precisely, in the case of a conveying fiber having a diameter of 50 μm, the BPP of which is between 1.6 and 2.2 mm.mrad, the focal length of the collimating lens is between 70 and 120 mm, preferably between 70 and 90 mm. To cut a material having a thickness of strictly less than 10 mm, the focusing lens focal length is advantageously between 200 and 300 mm, preferably between 220 and 280 mm, whereas to cut a material having a thickness of 10 mm or more, the focusing lens focal length is advantageously between 350 and 450 mm, preferably between 380 and 420 mm;
the conveying fiber (FDC) has a diameter of 100 μm and a BPP of between 2.6 and 4 mm.mrad, the collimating lens has a focal length of between 130 and 180 mm and the focusing lens has a focal length of between 200 and 450 mm. More precisely, in the case of a conveying fiber with a diameter of 100 μm, the BPP of which is between 2.6 and 4 mm.mrad, the focal length of the collimating lens is between 130 and 180 mm, preferably between 140 and 180 mm. To cut a material having a thickness strictly less than 10 mm, the focusing lens focal length is advantageously between 200 and 300 mm, preferably between 220 and 280 mm, whereas to cut a material having a thickness of 10 mm or more, the focusing lens focal length is advantageously between 350 and 450 mm, preferably between 380 and 420 mm; and
the focusing lens has a focal length of between 200 and 450 mm.

Moreover, the invention also relates to a laser cutting process for cutting a metal part, in which a focusing head or a laser cutting unit according to the invention is employed.

The present invention, which relates especially to a particular optical configuration used in a fiber laser cutting head, will be better understood from the following detailed description and the appended figures in which:

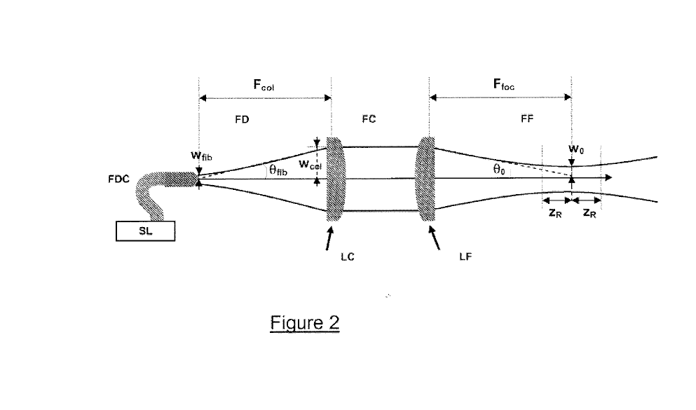

FIG. 2 shows the basic principle of a typical optical system for a cutting head and the characteristic parameters of the laser beam propagating through the optical system;

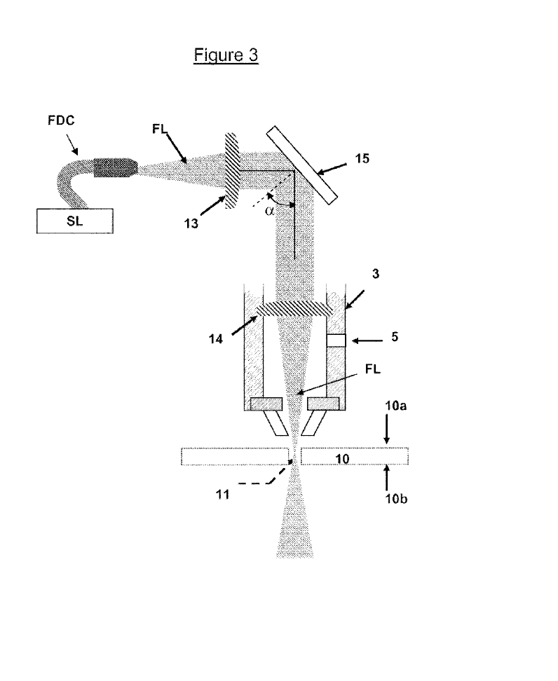

FIG. 3 shows schematically the operating principle of a laser cutting unit and a laser cutting process according to the invention;

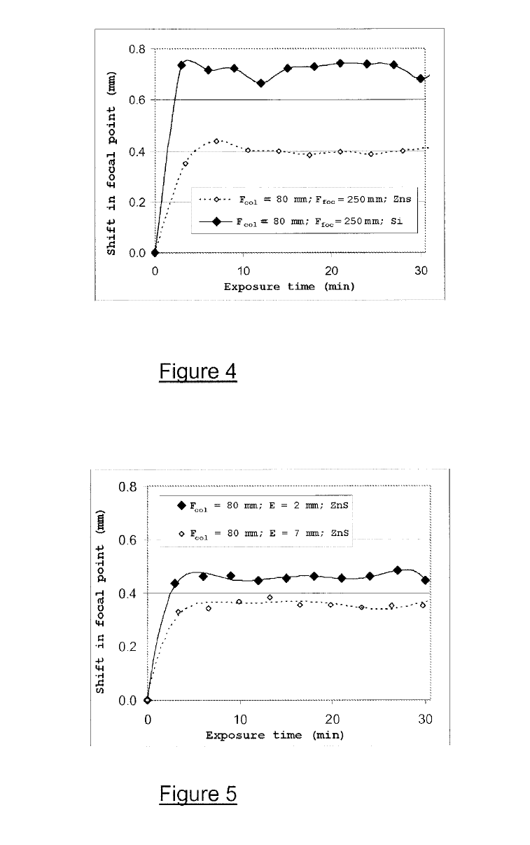

FIG. 4 shows a comparison between the variation in the position of the focal point of the beam during laser irradiation of a system of lenses made of ZnS and that of lenses made of fused silica (Si); and

FIG. 5 is a comparison between the change in the position of the focal point of the beam focused by a system of lenses made of ZnS that includes a collimating lens having a thickness at the edges of 2 mm and that of one having a thickness at the edges of 7 mm.

A cutting unit according to the invention comprises a solid-state laser source SL equipped with at least one beam-conveying optical fiber FDC and a focusing head 3, also called a cutting head, for transporting and focusing the laser beam FL onto or into the part 10 to be cut. The characteristics and the operating ranges of the unit are explained below and illustrated in FIG. 3.

The cutting head 3 conventionally comprises optical devices for collimating, redirecting and focusing the laser beam.

Moreover, the laser beam is emitted by a solid-state laser device or generator, preferably an ytterbium (Yb)-doped fiber laser. In the laser device, the lasing effect, that is to say the light amplification phenomenon for generating the laser radiation, is obtained by means of an amplifying medium preferably pumped by laser diodes and consisting of one or typically several doped optical fibers, preferably ytterbium-doped silica fibers.

The wavelength of the radiation emitted as output by the laser device is between 1.06 and 1.10 μm and the laser power is between 0.1 and 25 kW, typically between 1 and 5 kW.

The laser may operate in continuous, quasi-continuous or pulsed mode, but the present invention is particularly advantageous when it is operated in continuous mode as this is the severest irradiation mode for the optics of a cutting head. The beam generated by the solid-state laser source is emitted and conveyed right to the focusing head by means of at least one optical conveying fiber made of undoped silica, having a diameter of less than 150 μm, for example equal to 50 or 100 μm.

In general, by using a high-brilliance laser source, such as fiber lasers, it is possible to generate high-power beams with an excellent quality factor. The degree of quality of a laser beam is measured by its quality factor or beam parameter product (BPP). The BPP is determined by the characteristics of the laser source SL and the diameter of the conveying fiber FDC. It is expressed as the product of the radius w₀ at the waist of the focused laser beam multiplied by its divergence half-angle θ₀, as illustrated in FIG. 2. The BPP is also defined by the product of the radius w_{fib} of the optical conveying fiber emitting the laser beam multiplied by the divergence half-angle θ_{fib} of the beam output by the fiber. Thus, for a 50 μm fiber, the BPP of the beam is typically between 1.6 and 2 mm.mrad, whereas for a 100 μm fiber the BPP is typically between 2.7 and 4 mm.mrad.

As illustrated in FIG. 2, the focusing system of the laser cutting head is made up, in succession, in the direction of propagation of the laser beam, of at least one collimating lens LC for obtaining a collimated beam FC from a divergent beam FD, and of at least one focusing lens LF for obtaining a focused beam FF and for concentrating the energy of the laser onto the part to be cut. The focal lengths of the collimating and focusing lenses are chosen so as to obtain a focal spot with a diameter suitable for having the power density necessary for cutting the part.

The diameter 2w₀ of the beam in the focal plane is defined as the product of the diameter 2w_{fib} of the fiber multiplied by the optical magnification G of the focusing system and expressed by:

$$2 {w}_{0} = 2 {w}_{fib} G = 2 {w}_{fib} \frac{{F}_{foc}}{{F}_{col}}$$

where:
G is given by the ratio of the focal length F_{foc} of the focusing lens FC to the focal length F_{c01} of the collimating lens LC; and
w₀ and w_{fib} are the characteristic radii of the beam in the focal plane and of the fiber, respectively. The expression “characteristic radius w” is understood to mean the distance from the optical axis where the intensity drops to 1/e² (about 13.5%) of its maximum value, which means that 86.5% of the power of the beam lies within the disk of radius w. All the beam parameters are defined according to this criterion.

The radius of the beam irradiating the collimating and focusing optics is given by the following equation:

w_{col}=θ_{fib}F_{col}.

The divergent half-angle θ_{fib} of the beam emitted by the conveying fiber is derived from the value of the BPP of the focused beam through the equation:

BPP=w₀θ₀=w_{fib}θ_{fib}.

The average power density per unit area, also called the power density (DP) and expressed in kW/cm², irradiating the optics is defined as follows:

$$DP = \frac{{P}_{las}}{π {w}_{col}^{2}}$$

where: Pₗₐₛ is the total power of the radiation emitted by the laser source and w_{col} is the characteristic radius of the beam irradiating the optics.

The problems arising when using a high-brilliance laser generator, such as a fiber laser, are thus understood, namely the fact that:
this type of source is characterized by a low BPP and therefore by beams having a lower divergence θ_{fib} at fiber exit. This parameter corresponds to the rate of expansion in far field of the beam emitted by the conveying fiber and determines the diameter of the beam on the optics of the system. For the same collimating focal length, a beam of higher quality, and therefore of lower divergence, has a smaller diameter 2w_{col} on the collimating lens. This results in an increase in the DP. By way of indication, table 1 below compares the typical beam characteristics for various lasers and also the power densities obtained on the optics for a power of 2 kW and a collimating lens focal length of 100 mm; and
for the same optical magnification, a beam of lower BPP is focused with the same focal diameter but has a lower divergence θ₀. Its Rayleigh length z_{R}=w₀/θ₀ is longer while the shift in the focal point caused by the focusing system heating up at high power is proportional to z_{R}.

TABLE 1

| | | | Fiber |
|---|---|---|---|
| Laser source | Nd:YAG (1.06 μm) | | (1.07 μm) |
| Pumping | Lamps | Diodes | Diodes |
| Typical fiber diameter | 600 | 400 | 100 |
| (μm) | | | |
| Typical BPP (mm · mrad) | 25 | 15 | 3 |
| Divergence θ_{fib} (mrad) | 83 | 75 | 60 |
| 2w_{col} (mm) for | 16.7 | 15.0 | 12.0 |
| F_{col} = 100 mm | | | |
| DP at 2 kW (kW/cm²) | 0.9 | 1.1 | 1.8 |

This table shows that the power density on the lenses increases when the beam quality increases. However, the magnitude of the thermal gradient set up in the optics under laser irradiation increases with the power density withstood by the optics. It is therefore astute to work with optics having the best possible thermal behavior so as to avoid the problems of focal drift and laser damage.

For this purpose, the optical system of the invention combines the specific features described below, as shown in the diagram in FIG. 3.

The cutting head 3 consists of optical devices working in transmission, that is to say here lenses 13, 14, serving for the operations of collimating (at 13) and focusing (at 14) the laser beam FL output by the conveying fiber and generated by the solid-state laser source SL.

Advantageously zinc sulfide (ZnS) is used as substrate for the collimating lens 13 and the focusing lens 14. This is because the magnitude of the thermal gradient established in the lenses under laser irradiation is inversely proportional to the thermal conductivity of the constituent material of the lenses. Now, the thermal conductivity of ZnS (0.272 W/cm/° C.) is around 20 times that of fused silica (0.0138 W/cm/° C.). This higher thermal conductivity corresponds to a higher capability of ZnS to dissipate heat, and enables the magnitude of the thermal gradients and distortions induced in the lenses by the high-power irradiation to be limited.

The optical collimating device 13 and the optical focusing device 14 may be chosen from various types of lenses available. The lenses are preferably singlets so as to limit the number of optical surfaces of the focusing system and to minimize the risk of damage. Lenses of various geometries may be used, for example plano-convex, biconvex or meniscus lenses. Preferably they are plano-convex lenses. All the optical surfaces preferably have an anitreflecting coating, antireflecting at the wavelength of the laser.

The lenses of the cutting head are placed in a thermally controlled support. Water circulates in the support and provides cooling by indirect contact with the lenses. The temperature of the water is between 19 and 25° C.

The thickness and the diameter of the lenses 13, 14 also have an influence on their thermal behavior. The larger the dimensions of the lenses, the better the heat dissipation toward the cooler peripheral zones and the smaller the thermal gradients. In the conventional cutting heads, thick lenses are used, that is to say having a thickness at the edges of at least 5 mm, just for carrying out the focusing operation. This is because an assist gas is injected directly after the focusing lens, thereby exposing them to high pressures. The focusing lenses must therefore be thick so as to have good mechanical strength. In the context of the invention, to reduce the phenomenon of focal drift, thick lenses are used for both collimating and focusing the beam. Contrary to what is usually employed, the cutting head 3 therefore consists of lenses having a thickness at the edges of at least 5 mm, preferably between 6 and 8 mm. Just as a greater thickness offers better thermal behavior, larger-diameter optics dissipate the heat toward the edges better. Whatever the size of the beam impacting on the optics of the cutting head 3, the latter therefore employs lenses having a diameter of between 35 and 55 mm.

In the cutting head 3, a reflective component 15 is placed in the path of the laser beam 10 between the collimating lens 13 and the focusing lens 14. This component is a plane mirror and does not modify the beam propagation parameters. The substrate of the mirror is made of fused silica.

At least one face of the mirror has a reflecting coating. This coating consists of thin optical films and reflects the light at the wavelength of the laser cutting beam and at wavelengths between 630 and 670 nm. The coating is however transparent for part of the visible or infrared spectrum, including the wavelength of an illumination system, for example a laser diode. In this way it is possible to connect a process control device (of the camera or photodiode type) at the rear of the mirror. It operates at an angle of incidence a of between 40 and 50°, preferably 45°. The thickness of the mirror is between 3 and 15 mm, preferably between 8 and 12 mm First and foremost, the mirror helps to reduce the vertical dimension of the head, in order to improve mechanical stability. Moreover, in this configuration, the conveying fiber is kept horizontal, thereby reducing the risk of dust ingress when mounting and removing the fiber or the collimator. Finally, by incorporating a reflective component in the path of the beam it is possible to compensate for part of the focal drift caused by the lenses. Specifically, the longitudinal displacement of the focal point caused by a reflective component takes place in the opposite direction from the focal drift caused by a transmissive component.

The lenses of the cutting head 3 are also characterized by specific focal lengths that are matched to the BPP of the conveying fiber used. These focal lengths are necessary for obtaining the focal spot diameter 2w₀ suitable for cutting the material treated. For a conveying fiber of 50 μm diameter, the BPP of the beam is typically between 1.6 and 2.2 mm.mrad. For this fiber, the focal length of the collimating lens is between 70 and 120 mm, preferably between 70 and 90 mm. The choice of collimating lens focal length then determines the choice of focusing lens focal length, depending on the desired optical magnification for cutting the thickness of material treated.

For materials having a thickness of strictly less than 10 mm, the focusing lens focal length is between 200 and 300 mm, preferably between 220 and 280 mm. For materials having a thickness of 10 mm or more, the focusing lens focal length is between 350 and 450 mm, preferably between 380 and 420 mm.

For a conveying fiber of 100 μm diameter, the BPP of the beam is typically between 2.6 and 4 mm.mrad. For this fiber, the focal length of the collimating lens is between 130 and 180 mm, preferably between 140 and 180 mm. For materials having a thickness of strictly less than 10 mm, the focusing lens focal length is between 200 and 300 mm, preferably between 220 and 280 mm. For materials having a thickness of 10 mm or more, the focusing lens focal length is between 350 and 450 mm, preferably between 380 and 420 mm.

The focusing head 3 is supplied with assist gas via a gas inlet 5 provided in the wall of said focusing head 3, via which a pressurized gas or gas mixture coming from a gas source, for example one or more gas bottles, a storage tank or else one or more gas lines, such as a gas delivery system, is introduced upstream of the nozzle 4 and discharged via this nozzle 4 toward the part 30 to be cut by the laser beam.

The assist gas serves to expel the molten metal out of the cutting kerf 12 obtained by melting the metal by means of the laser beam FL, which is focused at the position 11 relative to the surface of the part 10 to be cut.

The choice of gas is made according to the characteristics of the material to be cut, especially its composition, its grade and its thickness. For example, air, oxygen, nitrogen/oxygen or helium/nitrogen mixtures may be used for cutting steel, whereas nitrogen, nitrogen/hydrogen or argon/nitrogen mixtures may be used for cutting aluminum or stainless steel.

In fact, the part 10 to be cut by laser cutting may be formed from various metallic materials, such as steel, stainless steel, mild steel or light alloys, such as aluminum and aluminum alloys, or even titanium and titanium alloys, and may typically have a thickness of between 0.1 mm and 30 mm.

During the cutting process, the laser beam may be focused (at 11) in the thickness or on or in the immediate vicinity of one of the surfaces of the part 10, that is to say outside and a few mm above the upper surface 10a or beneath the lower surface 10b of the part 10, or onto the upper surface 10a or lower surface 10b. Preferably, the position 11 of the focal point lies between 5 mm above the upper surface 10a and 5 mm beneath the lower surface 10b of the part 10.

By virtue of the present invention, the focusing position of the laser beam is kept stable during the cutting process since any focal drift and any damage of the optics are avoided or minimized, thereby ensuring substantially constant performance throughout the length of the laser cutting operation.

The benefit of using one or more lenses made of ZnS, rather than made of fused silica, in a laser cutting head was demonstrated by comparing the focal drift induced when these two types of lenses were exposed to high power.

To do this, two optical systems each consisting of a collimating lens of 80 mm focal length and a focusing lens of 250 mm focal length were compared. One system consisted of ZnS lenses and the other of fused silica lenses.

The caustic of the laser beam focused by each system was recorded using a beam analyzer. This device measures the beam radius for which 86% of the laser power is contained within a disk of this radius within successive planes of propagation lying over a distance of about 10 mm on either side of the waist of the focused beam.

From the recorded caustic, it is possible to determine the position of the focal plane of the laser beam along its propagation direction. The change in the position of the focal plane during prolonged exposure of the focusing optics may be monitored by carrying out a series of beam analyses.

During these trials, each optical system was exposed for about 30 minutes. In the optical configuration investigated, the beam had a diameter of 9.6 mm on the lens, resulting in a power density of around 2.8 kW/cm² at 2 kW.

FIG. 4 compares the change in the position of the focal point of the beam focused by a system of lenses made of ZnS with those made of fused silica (Si). For each curve, the first point corresponds to the position recorded during a first beam analysis carried out a 200 W. At this power, the focal shift caused by the thermal lensing effect is negligible. The measured position may be considered to correspond to the position where the focal point of the beam lies immediately after turning the laser on. It is then from this position that the focal shift is measured. The first point on the curves therefore corresponds to a zero shift in the focal point.

FIG. 5 shows that for the longitudinal shift of the focal point is greater for the fused silica (Si) system than for the ZnS system. The use of ZnS thus helps to reduce the magnitude of the shift of the focal point during irradiation of optics at high power.

The effect of a variation in the thickness at the edges of the collimating lens was also studied. To do this, the magnitude of the displacement of the focal point obtained with a system of ZnS lenses including a collimating lens with a thickness E at the edges of 2 mm was compared with a system including a collimating lens having a thickness E at the edges of 7 mm.

FIG. 5 compares the change in the position of the focal point of the beam focused by the two systems by using the method described above.

It may be seen that the longitudinal shift of the focal point is greater when the collimating lens is thinner.

By combining the optical devices of the invention it is possible to guarantee the performance durability of the laser cutting process, in particular in the case of a laser cutting process using a solid-state laser, in particular a fiber laser, by keeping the magnitude of the focal drift and the problems of damaging the optics under control.

1-13. (canceled)

14. A laser beam focusing head comprising a collimating lens and a focusing lens, wherein:
the collimating lens and the focusing lens are made of ZnS and have a thickness at the edges of at least 5 mm, and
a deflecting mirror operating at an angle of incidence (α) of between 40 and 50° is placed, in the path of the laser beam within said focusing head, between the collimating lens and the focusing lens.

15. The focusing head of claim 14, in which the collimating lens and the focusing lens have a thickness at the edges of between 5 and 10 mm.

16. The focusing head of claim 15, in which the collimating lens and the focusing lens have a thickness at the edges of between 6 and 8 mm.

17. The focusing head of claim 14 in which the collimating lens and the focusing lens have a diameter of between 35 and 55 mm.

18. The focusing head of claim 14 in which the deflecting mirror is made of silica.

19. A laser cutting unit comprising:
a solid-state laser device emitting a laser beam at a wavelength of between 1.06 and 1.10 μm and a power of between 0.1 and 25 kW,
a focusing head of claim 14; and
a conveying fiber connecting the solid-state laser device to the focusing head so as to convey the laser beam emitted by the solid-state laser device to the focusing head.

20. The unit of claim 19 in which the solid-state laser device is of the fiber laser type.

21. The unit of claim 20, wherein the solid-state laser devices is an ytterbium-doped fiber laser.

22. The unit of claim 19 in which the solid-state laser device emits a laser beam with a power of between 1 and 5 kW in continuous, quasi-continuous or pulsed mode,

23. The unit of claim 22, wherein the solid-state laser devices operates in continuous mode.

24. The unit of claim 19, in which the conveying fiber has a diameter not exceeding.

25. The unit of claim 24, in which the conveying fiber has a diameter of 50 μm.

26. The unit of claim 24, in which the conveying fiber has a diameter of 100 μm.

27. The unit of claim 19 in which the solid-state laser device emits a laser beam having a BPP of between 1.6 and 4 mm.mrad.

28. The unit of claim 19 in which the conveying fiber has a diameter of 50 μm and a BPP of between 1.6 and 2.2 mm.mrad, and the collimating lens has a focal length of between 70 and 120 mm.

29. The unit of claim 19 in which the conveying fiber has a diameter of 100 μm and a BPP of between 2.6 and 4 mm.mrad, and the collimating lens has a focal length of between 130 and 180 mm.

30. The unit of claim 19 in which the focusing lens has a focal length of between 200 and 450 mm.

31. A laser cutting process for cutting a metal part, in which a focusing head as or a laser cutting unit of claim 18 is employed.
